(19) United States
(12) Patent Application Publication
(10) Pub. No.: US 2023/0133173 A1
(43) Pub. Date: May 4, 2023

(54) GROUP-CONTROLLED SMART BLOCKS AND APPARATUS FOR CONTROLLING THE SAME

(71) Applicant: CREAMO Inc, Seoul (KR)

(72) Inventors: Seok LEE, Seoul (KR); Ganghyun CHO, Seongnam-si (KR)

(21) Appl. No.: 18/051,299

(22) Filed: Oct. 31, 2022

(30) Foreign Application Priority Data
Oct. 29, 2021 (JP) 2021-177296
Sep. 8, 2022 (KR) 10-2022-0114406

(51) Int. Cl. G05B 13/02

(52) U.S. Cl. CPC G05B 13/0205

(57) ABSTRACT

Group-controlled smart blocks configured to form a group of n smart blocks each having a unique ID and performing a given function include a master block assigned by an external control device among the n smart blocks and n-1 slave blocks other than the master block. The master block is configured to receive a program from the external control device and to transmit to each of the n-1 slave blocks a first command for performing a corresponding function, and each of the n-1 slave blocks is configured to receive the first command from the master block and to perform the corresponding function.

### CROSS-REFERENCE TO RELATED APPLICATIONS

This application is based upon and claims the benefit of priority from Japanese Patent Application No. 2021-177296, filed Oct. 29, 2021 and Korean Patent Application No. 10-2022-0114406, filed Sep. 8, 2022, the entire contents of which are incorporated herein by reference.

### BACKGROUND

### Technical Field

The present disclosure relates to group-controlled smart blocks and an apparatus for controlling the same.

### Description of Related Technology

A block-based toy or teaching tool is a member for aiding play or education by connecting or arranging a plurality of blocks formed in various three-dimensional shapes. Children can improve cognitive skill, intelligence, and creativity with provision of play and educational effect through various block-based toys or teaching tools.

A smart block, which is such a block equipped with communication and various functions, can provide the children with more upgraded play, educational effect, and improvement of cognitive skill, intelligence, and creativity through expansion of functionality using a board as well as the functionality of the block itself (see, for example, Korean Patent No. 10-1714642 and Korean Patent No. 10-1739029).

Recently, researches have focused on approach to education or medical treatment with digital therapy without using a medicine, and therefore, a digital therapy is demanded for autistic children who show disorders in sociality or personal relation, development retardation in communication skill or language, bias in action or interest, and the like.

### SUMMARY

According to some embodiments of the present disclosure, group-controlled smart blocks configured to form a group of n smart blocks each having a unique ID and performing a given function include a master block assigned by an external control device among the n smart blocks and n-1 slave blocks other than the master block. The master block is configured to receive a program from the external control device and to transmit to each of the n-1 slave blocks a first command for performing a corresponding function, and each of the n-1 slave blocks is configured to receive the first command from the master block and to perform the corresponding function.

According to some embodiments of the present disclosure, a control device for controlling group-controlled smart blocks configured to form a group of n smart blocks each having a unique ID and performing a given function includes a transmitting and receiving unit configured to communicate with the n smart blocks, a connecting unit configured to receive a connection signal from each of the n smart blocks and to assign the n smart blocks in a group, and a control unit configured to assign one of the n smart blocks as a master block and other smart blocks as n-1 slave blocks and to transmit a program to the master block. The program is configured to cause the master block to transmit to each of the n-1 slave blocks a first command for performing a corresponding function and to cause each of the n-1 slave blocks to receive the first command from the master block and to perform the corresponding function.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of group-controlled smart blocks according to some embodiments of the present disclosure;

FIG. 2 is a schematic diagram for explaining an operation example of the group-controlled smart blocks according to some embodiments of the present disclosure;

FIG. 3 is a schematic diagram for explaining operations of a master block and a slave block for implementing the group-controlled smart blocks according to some embodiments of the present disclosure;

FIG. 4 is a schematic diagram for explaining another operation example of the group-controlled smart blocks according to some embodiments of the present disclosure;

FIG. 5 is a schematic diagram for explaining operations of a master block and a slave block for implementing the group-controlled smart blocks shown in FIG. 4;

FIGS. 6 and 7 are schematic diagrams for explaining another operation example of the group-controlled smart blocks according to some embodiments of the present disclosure;

FIG. 8 is a functional block diagram of a group-controlled smart block according to some embodiments of the present disclosure;

FIG. 9 is a functional block diagram of a control device for controlling group-controlled smart blocks according to some embodiments of the present disclosure; and

FIG. 10 is a flowchart for explaining operations of the group-controlled smart blocks and the control device according to some embodiments of the present disclosure.

### DETAILED DESCRIPTION

Exemplary embodiments of the present disclosure are described in detail below with reference to the accompanying drawings.

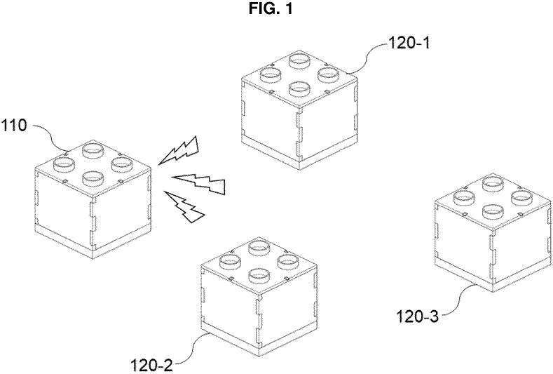

FIG. 1 is a schematic diagram of group-controlled smart blocks according to some embodiments of the present disclosure;

As shown in FIG. 1, group-controlled smart blocks according to some embodiments of the present disclosure form a group of n smart blocks each having a unique ID and performing a given function, including a master block 110 assigned by an external control device among the n smart blocks and n-1 slave blocks 120-1, 120-2, 120-3 other than the master block 110.

In some embodiments of the present disclosure, the master block 110 receives a program from the external control device and transmits to each of the n-1 slave blocks 120-1, 120-2, 120-3 a first command for performing a corresponding function.

In some embodiments of the present disclosure, each of the n-1 slave blocks 120-1, 120-2, 120-3 receives the first command from the master block 110 and performs the corresponding function.

Each of the n smart blocks constituting the group-controlled smart blocks according to some embodiments of the present disclosure includes a function unit for performing a corresponding function. Details on such function unit can be found in, for example, Korean Patent No. 10-1714642 and Korean Patent No. 10-1739029.

The function unit of each of the n smart blocks constituting the group-controlled smart blocks according to some embodiments of the present disclosure may include at least one or more of light-emitting function, recording function, display function, sound function, rotational or translational motion function, and the like. In some embodiments of the present disclosure, the master block 110 figures out the function of each of the slave blocks based on the ID of each of the n-1 slave blocks 120-1, 120-2, 120-3 and transmits the first command to cause each of the slave blocks to perform the corresponding function.

In the example shown in FIG. 1, the group-controlled smart blocks include four smart blocks of which one is assigned as the master block 110 and three smart blocks are assigned as the slave blocks 120-1, 120-2, 120-3, however, the number of smart blocks constituting the group-controlled smart blocks can be arbitrarily set and a plurality of master blocks can be assigned as necessary.

In some embodiments of the present disclosure, when a plurality of master blocks is assigned, the slave blocks can be divided into a plurality of sub groups and each of the master blocks can control the slave blocks in one sub group.

In some embodiments of the present disclosure, when a plurality of master blocks is assigned, one of the master blocks can be activated and the rest of the master blocks can stay in stand-by in reserve.

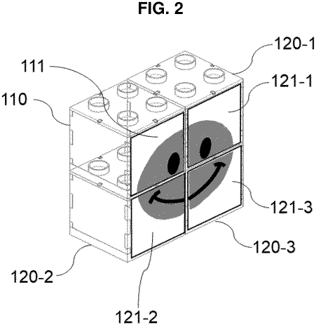

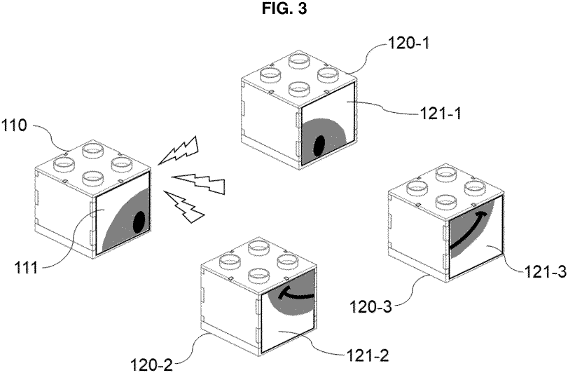

FIG. 2 is a schematic diagram for explaining an operation example of the group-controlled smart blocks according to some embodiments of the present disclosure. FIG. 3 is a schematic diagram for explaining operations of a master block and a slave block for implementing the group-controlled smart blocks according shown in FIG. 2.

In FIG. 2, an example of how the group-controlled smart blocks according to some embodiments is explained in which, in group-controlled smart blocks including four smart blocks, when four smart blocks are combined to form a proper plane, a smile is displayed in a multi-vision format on the plane formed with side plates of the smart blocks.

The complete image shown in FIG. 2 is presented to a user and then the four smart blocks are arbitrarily arranged as shown in FIG. 3. Thereafter, the master block 110 displays a part of the smile on its display 111 and transmits the first command to cause the slave blocks 120-1, 120-2, 120-3 to respectively display corresponding parts of the smile on their displays 121-1, 121-2, 121-3.

Upon receiving the first command from the master block 110, the slave blocks 120-1, 120-2, 120-3 respectively display the corresponding parts of the smile on their displays 121-1, 121-2, 121-3.

When the user completes the puzzle by correctly arranging the four smart blocks arbitrarily arranged, the smile is displayed on the displays 111, 121-1, 121-2, 121-3 in a multi-vision format as shown in FIG. 2.

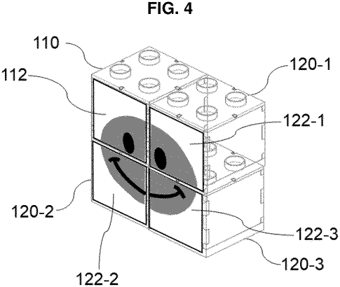

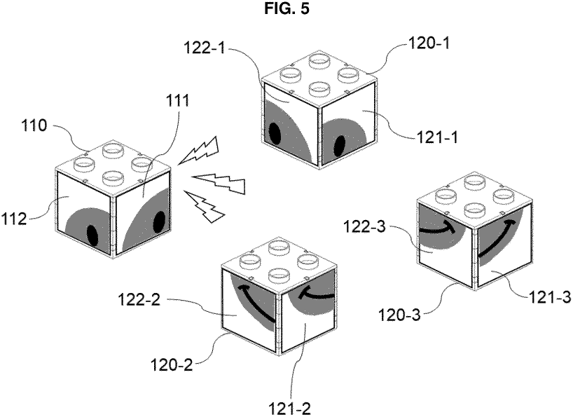

FIG. 4 is a schematic diagram for explaining another operation example of the group-controlled smart blocks according to some embodiments of the present disclosure. FIG. 5 is a schematic diagram for explaining operations of a master block and a slave block for implementing the group-controlled smart blocks shown in FIG. 4.

In the example shown in FIGS. 4 and 5, the level of difficulty of the puzzle can be increased by displaying the same image or a different image on sides of the smart blocks different from the display 111 of the master block 110 and the displays 121-1, 121-2, 121-3 of the slave blocks 120-1, 120-2, 120-3.

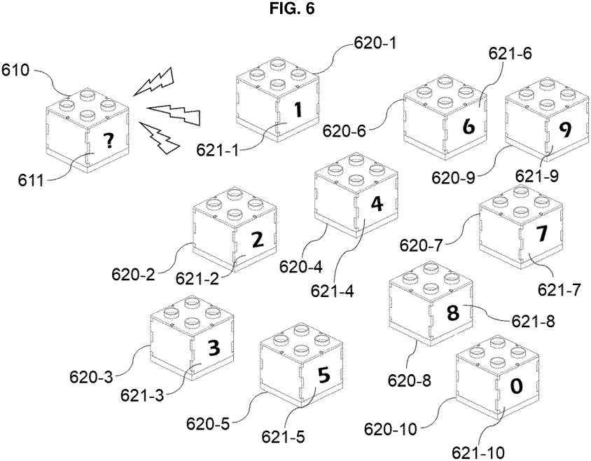

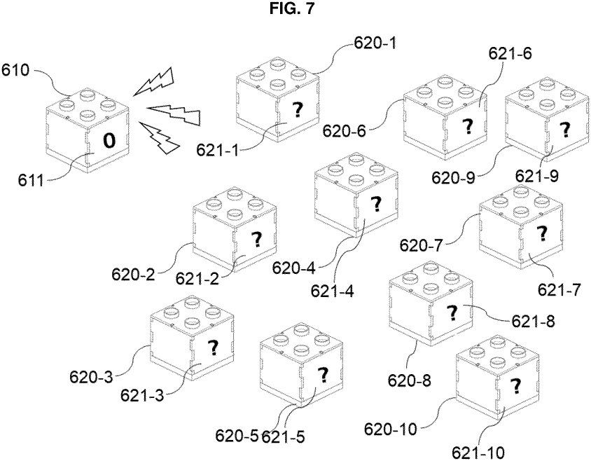

FIGS. 6 and 7 are schematic diagrams for explaining another operation example of the group-controlled smart blocks according to some embodiments of the present disclosure.

In the example shown in FIG. 6, in a group of group-controlled smart blocks including 11 smart blocks, one master block 610 and 10 slave blocks 620-1, 620-2, 620-3, 620-4, 620-5, 620-6, 620-7, 620-8, 620-9, 620-10 respectively display numbers from 0 to 9 on their displays 611, 621-1, 621-2, 621-3, 621-4, 621-5, 621-6, 621-7, 621-8, 620-9, 621-10.

Firstly, numbers displayed on the displays 621-1, 621-2, 621-3, 621-4, 621-5, 621-6, 621-7, 621-8, 620-9, 621-10 of the 10 slave blocks 620-1, 620-2, 620-3, 620-4, 620-5, 620-6, 620-7, 620-8, 620-9, 620-10 are presented to a user, and then the displays 621-1, 621-2, 621-3, 621-4, 621-5, 621-6, 621-7, 621-8, 620-9, 621-10 of the 10 slave blocks 620-1, 620-2, 620-3, 620-4, 620-5, 620-6, 620-7, 620-8, 620-9, 620-10 are turned off or the numbers displayed are changed to “?” as shown in FIG. 7.

Thereafter, the master block 610 displays a hint image on its display 611 (in the example shown in FIG. 7, one of the numbers from 0 to 9), and the user selects a slave block which he or she assumes to correspond to the image displayed on the display 611 of the master block 610 (in the example shown in FIG. 7, the number “0”).

When the user correctly select the slave block corresponding to the image displayed on the display 611 of the master block 610 (in this example, the slave block 620-10), the selected slave block displays the correct number on its display (in this example, the number “0” is displayed on the display 621-10 of the slave block 620-10).

Thereafter, the master block 610 deletes the correctly selected slave block (in this example, the slave block 620-10) from the group, repeats the same procedure for the rest of the slave blocks or leave the correctly selected block as it is and repeats the same procedure to increase the level of difficulty.

In some embodiments of the present disclosure, the master block transmits to each of the n-1 slave blocks a second command for pausing the corresponding function, and upon receiving the second command, the n-1 slave blocks pauses the corresponding function and performs again when a predetermined condition is met.

That is, the master block 610 transmits the first command to cause each of the slave blocks 620-1, 620-2, 620-3, 620-4, 620-5, 620-6, 620-7, 620-8, 620-9, 620-10 to display the corresponding number as shown in FIG. 6, and transmits the second command to cause each of the slave blocks 620-1 , 620-2, 620-3, 620-4, 620-5, 620-6, 620-7, 620-8, 620-9, 620-10 to turn off the corresponding number as shown in FIG. 7.

Turning off the display means to hide the original display, which includes turning off the display itself or displaying an image that has nothing to do with the original display (in the example shown in FIG. 7, “?”).

Thereafter, when a predetermined condition is met (in the example shown in FIG. 7, when the user selects the correct slave block), the corresponding slave block performs its function again (in the example shown in FIG. 7, when the user selects the slave block 620-10, the slave block 620-10 displays the number “0” on the display 621-10 again).

In some embodiments of the present disclosure, the master block 110 transmits the second command to the n-1 slave blocks 120-1, 120-2, 120-3 in a predetermined cycle.

In some embodiments of the present disclosure, the master block 110 transmits the second command to the n-1 slave blocks 120-1, 120-2, 120-3 upon a predetermined condition being met. The predetermined condition in the example shown in FIG. 7 includes the user’s selection of the slave block 620-10, and when this condition is met, the slave block 620-10 displays the number “0” on the display 621-10 again.

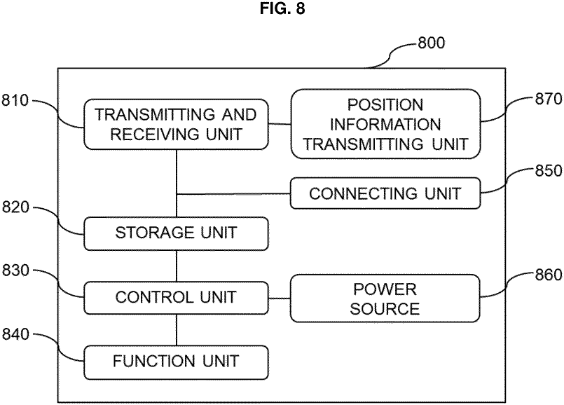

FIG. 8 is a functional block diagram of a group-controlled smart block according to some embodiments of the present disclosure.

As shown in FIG. 8, a smart block 800 constituting a group of group-controlled smart blocks includes a transmitting and receiving unit 810 for communicating with the external control device and other smart blocks, a connecting unit 850 for forming the group, a function unit 840 for performing the corresponding function, a control unit 830 for controlling the transmitting and receiving unit 810, the connecting unit 850, and the function unit 840, and a power source 860 for supplying power to the control unit 830.

In some embodiments of the present disclosure, the connecting unit 850 for constituting the group can be implemented, for example, a “Connect” button for a Bluetooth connection, such that upon being pressed, the external control device receives a connection request and accepts the connection request to connect the smart block and the control device with each other.

In some embodiments of the present disclosure, the smart block 800 further includes a storage unit 820 for storing group information including IDs of smart blocks in the same group.

In some embodiments of the present disclosure, the smart block 800 further includes a position information transmitting unit 870 for transmitting position information (for example, a beacon) via the transmitting and receiving unit 810. The control unit 830 of the master block receives the position information of each of the n-1 slave blocks and recognizes the position of each of the n-1 slave blocks based on the received position information.

By receiving the position information from each of the slave blocks and recognizing the position of each of the slave blocks, for example, when the slave blocks 620-1, 620-2, 620-3, 620-4, 620-5, 620-6, 620-7, 620-8, 620-9, 620-10 shown in FIG. 7 are arbitrarily arranged (shuffled), the master block can correctly transmit the commands to each of the slave blocks.

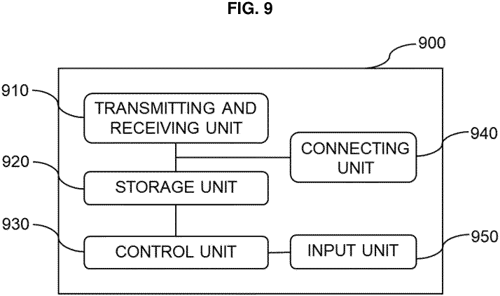

FIG. 9 is a functional block diagram of a control device 900 for controlling group-controlled smart blocks according to some embodiments of the present disclosure.

The control device 900 according to some embodiments of the present disclosure is configured to control group-controlled smart blocks configured to form a group of n smart blocks each having a unique ID and performing a given function.

In some embodiments of the present disclosure, the control device 900 includes a transmitting and receiving unit (or a transceiver) 910 configured to communicate with the n smart blocks, a connecting unit (or a connector) 940 configured to receive a connection signal from each of the n smart blocks and to assign the n smart blocks in a group, and a control unit (or a controller) 930 configured to assign one of the n smart blocks as a master block and other smart blocks as n-1 slave blocks and to transmit a predetermined program to the master block.

In some embodiments of the present disclosure, the program is configured to cause the master block to transmit to each of the n-1 slave blocks a first command for performing a corresponding function and to cause each of the n-1 slave blocks to receive the first command from the master block and to perform the corresponding function.

In some embodiments of the present disclosure, the control device 900 further includes a storage unit (or a storage) 920 for storing the program.

In some embodiments of the present disclosure, the control device 900 further includes an input unit 950 for receiving an input of the program.

In some embodiments of the present disclosure, when there is a target smart block to be deleted form the n-1 slave blocks, the connecting unit 940, the master block is configured to transmit an ID of the target block. Upon receiving the ID of the target smart block from the master block, the connecting unit 940 is configured to delete the target block from the group.

In some embodiments of the present disclosure, the connecting unit 940, upon receiving the connection signal from a third smart block other than the n smart blocks, the connecting unit 940 is configured to add the third smart block to the group or to assign the third smart block in a new group.

In some embodiments of the present disclosure, the control unit 930 can be configured to assign subset groups for the whole blocks and to perform a multi-group control for controlling a plurality of subset groups and a union of the subset groups.

In some embodiments of the present disclosure, the control unit 930 can be configured to control a master block for a specific set (for example, a union of subset group) with priority in the multi-group control.

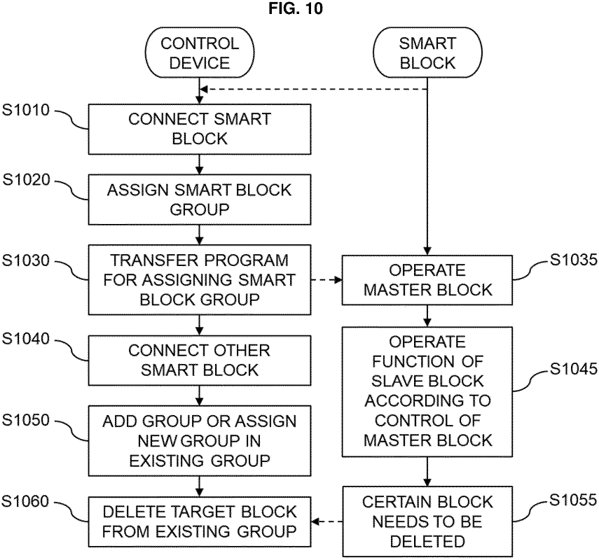

FIG. 10 is a flowchart for explaining operations of the group-controlled smart blocks and the control device according to some embodiments of the present disclosure.

Firstly, the control device receives a connection signal from a smart block (Step S1010), and assign the smart block from which the connection signal is received in a predetermined group (Step S1020).

When a group is ready with smart blocks of a predetermined number, the control device assigns at least one master block in the group and assigns the rest of the smart blocks as slave blocks. The control device transmits a predetermined program to the assigned master block (Step S1030).

Upon receiving the program, the master block starts an operation according to the program (Step S1035).

Thereafter, according to a command from the master block, each of the slave blocks performs a corresponding function (Step S1045).

Upon receiving a connection signal from a third smart block other than the smart blocks in the assigned group (Step S1040), the control device adds the third smart block to the assigned group or assigns the third smart block in a new group (Step S1050).

When there is a target block to be deleted from the group (Step S1055), the master block notifies the control device of the target block. Upon being notified of the target block, the control device deletes the target block from the group (Step S1060).

As described above, according to some embodiments of the present disclosure, it is possible to provide group-controlled smart blocks including a plurality of smart blocks formed in a group and controlled in group units.

Further, according to some embodiments of the present disclosure, it is possible to provide a control device for controlling group-controlled smart blocks including a plurality of smart blocks formed in a group and controlled in group units.

The present disclosure should not be limited to these embodiments but various changes and modifications are made by one ordinarily skilled in the art within the subject matter, the spirit and scope of the present disclosure as hereinafter claimed. Specific terms used in this disclosure and drawings are used for illustrative purposes and not to be considered as limitations of the present disclosure. Exemplary embodiments of the present disclosure have been described for the sake of brevity and clarity. Accordingly, one of ordinary skill would understand the scope of the claimed invention is not to be limited by the explicitly described above embodiments but by the claims and equivalents thereof.

What is claimed is:

1. Group-controlled smart blocks configured to form a group of n smart blocks each having a unique ID and performing a given function, the group-controlled smart blocks comprising:
a master block assigned by an external control device among the n smart blocks; and
n-1 slave blocks other than the master block, wherein:
the master block is configured to receive a program from the external control device and to transmit to each of the n-1 slave blocks a first command for performing a corresponding function, and
each of the n-1 slave blocks is configured to receive the first command from the master block and to perform the corresponding function.

2. The group-controlled smart blocks according to claim 1, wherein:
the master block is further configured to transmit to each of the n-1 slave blocks a second command for pausing the corresponding function, and
each of the n-1 slave blocks is configured to receive the second command from the master block, and when a predetermined condition is met, to perform again the corresponding function.

3. The group-controlled smart blocks according to claim 2, wherein the master block is configured to transmit the second command in a predetermined cycle.

4. The group-controlled smart blocks according to claim 2, wherein the master block is configured to transmit the second command when a predetermined condition is met.

5. The group-controlled smart blocks according to claim 1, wherein each of the n-1 slave blocks includes:
a transmitting and receiving unit configured to communicate with the external control device and other smart blocks;
a connecting unit configured to form the group;
a function unit configured to perform the corresponding function;
a control unit configured to control the transmitting and receiving unit, the connecting unit, and the function unit; and
a power source configured to supply power to the control unit.

6. The group-controlled smart blocks according to claim 5, wherein:
each of the n-1 slave blocks further includes a position information transmitting unit configured to transmit position information via the transmitting and receiving unit, and
the master is configured to receive the position information from each of the n-1 slave blocks and to recognize a position of each of the n-1 slave blocks based on received position information.

7. A control device for controlling group-controlled smart blocks configured to form a group of n smart blocks each having a unique ID and performing a given function, the control device comprising:
a transceiver configured to communicate with the n smart blocks;
a connector configured to receive a connection signal from each of the n smart blocks and to assign the n smart blocks in a group; and
a controller configured to assign one of the n smart blocks as a master block and other smart blocks as n-1 slave blocks and to transmit a program to the master block, wherein:
the program is configured to cause the master block to transmit to each of the n-1 slave blocks a first command for performing a corresponding function and to cause each of the n-1 slave blocks to receive the first command from the master block and to perform the corresponding function.

8. The control device according to claim 7, further comprising a storage configured to store the program.

9. The control device according to claim 7, further comprising an input unit configured to receive an input of the program.

10. The control device according to claim 7, wherein:
when there is a target smart block to be deleted form the n-1 slave blocks, the master block is configured to transmit an ID of the target block, and
upon receiving the ID of the target smart block from the master block, the connector is configured to delete the target block from the group.

11. The control device according to claim 7, wherein upon receiving the connection signal from a third smart block other than the n smart blocks, the connector is configured to add the third smart block to the group or to assign the third smart block in a new group.
